(19) United States
(12) Patent Application Publication
(10) Pub. No.: US 2008/0094229 A1
(43) Pub. Date: Apr. 24, 2008

(54) Light-Emitting Device

(75) Inventors: Oscar Marchetto, Oderzo (IT); Roberto Gherlenda, Oderzo (IT)

Correspondence Address: KATTEN MUCHIN ROSENMAN LLP, 575 MADISON AVENUE, NEW YORK, NY, 10022-2585, US

(73) Assignee: NICE SPA, Oderzo (Treviso) (IT)

(21) Appl. No.: 11/912,016

(22) PCT Filed: Apr. 6, 2006
(86) PCT No.: PCT/EP06/61391

§ 371 Date: Jan. 11, 2008

(30) Foreign Application Priority Data
Apr. 22, 2005 (IT) TV2005A000055

(51) Int. Cl. G08B 23/00; G08B 5/38

(52) U.S. Cl. 340/573.1; 340/815.73

(57) ABSTRACT

A device (10; 50; 61; 64; 100) which is associated with a system for the automatic movement of sliding gates or shutters and is characterized in that it comprises a light emitter and at least one functional unit (28, 56, 58, 66, 70, 72) able to manage the functions for interfacing with said system.

The present invention relates to a light-emitting device used in particular in association with gates, doors, entrances or shutters movable by means of an automatic movement system.

In all the automatic movement systems for sliding gates—for the sake of simplicity reference will be made below to the latter—doors, entrances or shutters a series of devices for ensuring the control and safety of the system are present.

Devices for operating and controlling the movement system may consist of: a control unit, an ON/OFF electric switch, a key-operated switch, a keypad, a transponder and a remote control device.

System safety devices, such as a series of photocells, a sensing edge and a light diffuser for signalling to the user by means of flashing that the gate is in movement, are also present. The purpose of these devices is to prevent accidents in the case where somebody inadvertently stands along the movement path of the gate.

All the devices mentioned are arranged within the area where the gate is installed, especially the safety devices. Clearly, connecting them requires complex wiring and many hours of costly labour by a specialised installation operator.

The movement system is therefore fairly complex, resulting in high costs.

The object of the present invention is to solve some of the drawbacks of the known automatic movement systems for sliding gates or shutters.

This object is achieved with a device, characterized in that it comprises at least one light emitter and at least one functional unit able to manage functions of interfacing with said automatic movement system.

Combining a light emitter and at least one functional unit able to manage functions of interfacing with the automatic movement system—and therefore overcoming the widely held view that illuminating, signalling and/or courtesy light emitters are mere mono-functional lighting components—greatly simplifies the wiring and the organization of the system, since it is possible to group together in one point several functional units, not only reducing the wires but also favouring integration between the said units. The functional unit associated with the light emitter may also manage functions of interfacing with said system and a user, in which case advantageously it may be interactive with the user, improving the performance of the said system. The functional unit may interact moreover with other parts of the automatic movement system.

Further advantages and characteristic features will emerge more clearly from the following description of a preferred embodiment of the invention, provided by way of example, with reference to the accompanying drawings, in which:

FIG. 1 shows a front view of a device according to the invention;

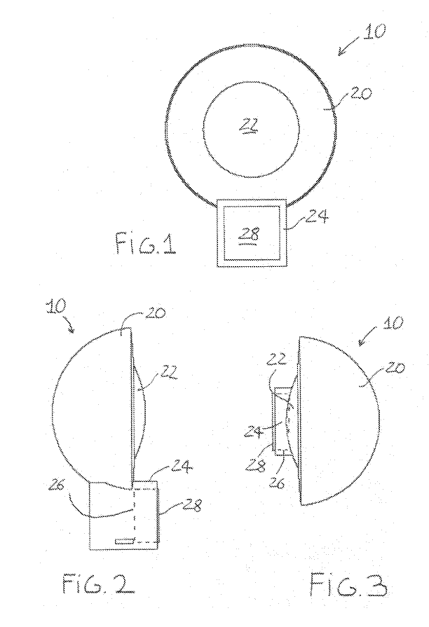

FIG. 2 shows a side view of the device according to FIG. 1;

FIG. 3 shows a view, from above, of the device according to FIG. 1;

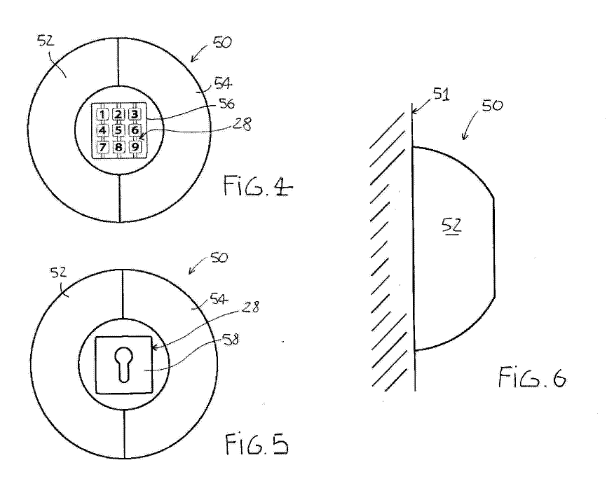

FIG. 4 shows a front view of a first variant of the device according to the invention;

FIG. 5 shows a front view of a variant of FIG. 4;

FIG. 6 shows a side view of the variant according to FIG. 4;

FIG. 7 shows a front view of a second variant of the device according to the invention;

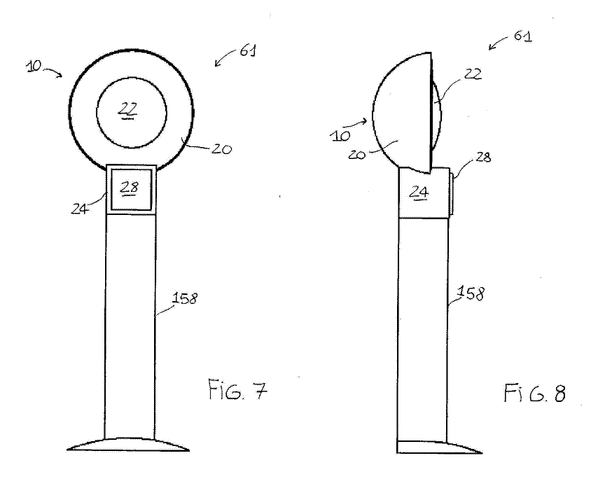

FIG. 8 shows a side view of the variant according to FIG. 7;

FIG. 9 shows a front view of a third variant of the device according to the invention;

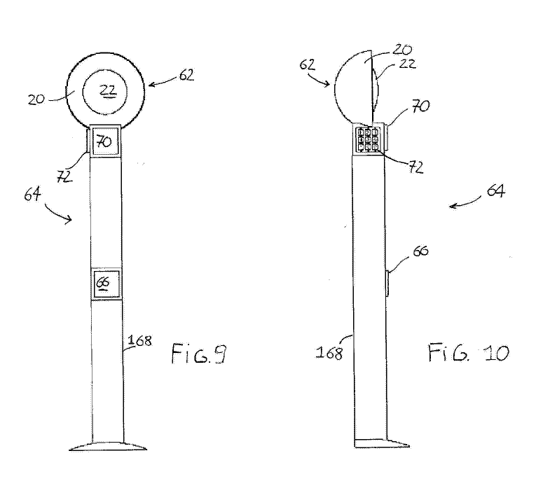

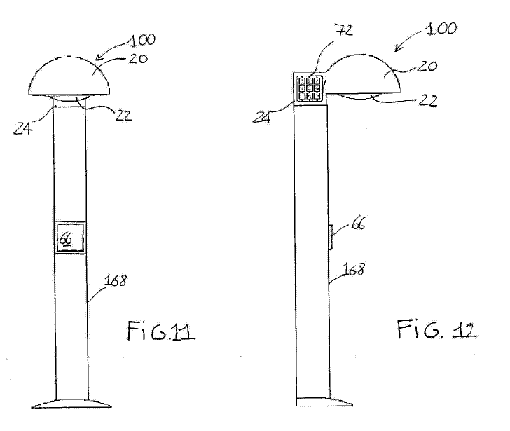

FIG. 10 shows a side view of the variant according to FIG. 9;

FIG. 11 shows a front view of a fourth variant of the device according to the invention;

FIG. 12 shows a side view of the variant according to FIG. 11.

With reference to FIGS. 1 to 3, a light-emitting device for sliding gates or shutters according to invention is indicated by 10. It comprises a hemispherical cover 20 which contains a flashing light-emitting source 22 and is supported by a substantially cube-shaped base 24. Said base 24 has formed in it a seat 26 (shown in broken lines in FIG. 2 and 3) which may receive, inserted therein, an interactive element 28 which manages functions of interfacing with the automatic movement system, for example for a user.

Examples for a functional unit 28 of this type may be a remote control device for a gate, a display, a push-button pad, a transponder-type proximity card reader, a key-operated switch with lock, an intercom or a finger print reader. Where said functional unit 28 does not interact with the user, but with the movement system (in particular with its control unit), it may consist of a photocell (or other presence sensor), a movement sensor, a weather sensor or a centralised control device for operating sliding gates or shutters.

The functional unit 28 may be a module which is interchangeable within the device 10 or fully integrated inside it. In the first case, said functional unit 28 comprises means for electrical and mechanical connection to the emitter 10, for example electrical connectors (advantageously quick-fit connectors), support brackets or screws. The functional unit 28 may also comprise means for wireless transmission to a control unit, for example a radio or infrared transceiver.

The innovative idea of the light-emitting device 10 according to the invention may be applied to an already known flashing safety light used in association with gates, doors, entrances or shutters movable by means of an automatic movement system.

In an advantageous variant of the invention more than one functional feature is integrated in the light-emitting device. FIG. 4 shows a round wall lamp 50. In it two identical circle segments 52, 54 form the light-emitting surface for a flashing lamp and for a courtesy light or other constant light source. The wall lamp 50 has, in the centre, a functional unit 28 which, if designed to interface the user with the system, may be for example, as well as the optional device for controlling the courtesy light, an alphanumeric keypad 56 or a key-operated switch with lock 58 (FIG. 5). Said wall lamp 50 may be arranged on a wall 51 adjacent to, or in the area surrounding, the gate, so that it may be easily reached by the user and/or adequately illuminate the gate.

In another advantageous variant of the invention, the light-emitting device may be used as a component for illuminating the vicinity of the gate—also with a courtesy light—and facilitate the movements of the user in the dark. For this purpose—see FIGS. 7 and 8—a device 61 may be positioned in the area surrounding the gate and, in order to raise either a light emitter or a functional unit to a desired height from the ground, it may comprise, for example, a support post 158, also performing the function of a lamp.

The light-emitting device 64 which can be seen in FIG. 9 and FIG. 10 incorporates a light source in a support for a photocell. At a desired height from the ground a post 168 incorporates a photocell 66 for controlling a gate (not shown), while the top of said post 168 incorporates a component 62 (formed like the device 10 in FIGS. 1, 2 and 3 for example) provided with one or more functional units, such as for example another photocell 70 (for additional protection or control)—FIG. 9—and/or a keypad 72 (for interfacing between the user and the automatic movement system or, also, an external system)—FIG. 10.

The orientation of the light source in the light-emitting device according to the invention may vary: from vertical in order to illuminate a path or a gate, to horizontal in order to illuminate the device itself (providing a reference point) or a functional unit which requires optimum night-time visibility—as in the device 100 which can be seen in FIG. 11 and FIG. 12. In these two figures, parts identical to those in FIGS. 8 and 9 are indicated, the only change being the inclination of the cover 20 and the position of the keypad 72. Other combinations are obviously possible with other functional units, including for example a finger print reader.

In all these variants the device according to the invention retains the advantage that it combines some functional units of the gate movement system with lighting components and also (especially at night-time) it forms a convenient reference point for the user, who will be able to determine the position of certain controls and be able to operate them with excellent visibility (a good example is the situation where one has to insert an opening key into a lock). Therefore, another advantage of the invention is that it saves on the need for accessory lighting sources for the components of the movement system.

Clearly, depending on the use of the device, it may comprise one or more functional units which are arranged in the base 24 or the cover 20, on the wall lamp 50 or on the post 68 or 168. The same light-emitting device may combine one or more light emitters and serve as a flashing lamp, courtesy light or constant lighting element, only requiring suitable control means—preferably electronic control means—for the light source (light bulb, led, neon lamp, etc.) and therefore for its emission.

These and other variants are included within the scope of protection of the following claims.

1. Device (10; 50; 61; 64; 100) associated with a system for automatic movement of sliding gates or shutters, characterized in that it comprises at least one light emitter and at least one functional unit (28, 56, 58, 66, 70, 72) able to manage functions of interfacing with said automatic movement system.

2. Device (10; 50; 61; 64; 100) according to claim 1, in which said at least one unit (28, 56, 58, 66, 70, 72) manages functions of interfacing with said system and a user.

3. Device (10; 50; 61; 64; 100) according to claim 2, in which said at least unit (28, 56, 58, 66, 70, 72) is interactive with the user.

4. Device (10; 50; 61; 64; 100) according to claim 2, in which said at least one unit (28, 56, 58, 66, 70, 72) is a remote control device for operating the sliding gate or shutter of said system, and/or a display and/or a keypad (56) and/or finger print reader and/or a key-operated switch (58).

5. Device (10; 50; 61; 64; 100) according to claim 1, in which said at least one unit is a sensor (28, 66, 70, 72) and/or a photocell (66, 70).

6. Device (10; 50; 61; 64; 100) according to claim 1, in which said at least one functional unit (28, 56, 58, 66, 70, 72) interfaces with the automatic movement system by means of wireless data transmission means.

7. Device (10; 50; 61; 64; 100) according to claim 1, in which said at least one functional unit (28, 56, 58, 66, 70, 72) is a module distinct from the device (10; 50; 61; 64; 100) and comprises means for electrical connection to the said device (10; 50; 61; 64; 100).

8. Device (10; 50; 61; 64; 100) according to claim 1, in which said at least one functional unit (28, 56, 58, 66, 70, 72) is housed inside a corresponding seat (26) in the body (28) of the said device (10; 50; 61; 64; 100).

9. Device (10; 50; 61; 64; 100) according to claim 1, comprising means for controlling the light emission of said at least one emitter so as to perform the function of a flashing lamp and/or constant lighting element.

10. Device (10; 50; 61; 64; 100) according to claim 1, comprising a support post (158; 168) for supporting said at least one emitter and/or said at least one functional unit at a desired height from the ground.

11. Device (10; 50; 61; 64; 100) according to claim 10, in which said post (158, 168) combines a photocell (66) and/or a light source (22).

12. Device (10; 50; 61; 64; 100) according claim 1, comprising two circle segments (52, 54) which form the light-emitting surface for a corresponding flashing lamp and for a constant light source.

13. Light emitter, characterized in that it comprises a seat (26) for an interactive element (28) which manages functions of interfacing with the automatic movement system and/or a user thereof.
